(19) United States
(12) Patent Application Publication
(10) Pub. No.: US 2006/0249436 A1
(43) Pub. Date: Nov. 9, 2006

(54) Pallet defect inspection systems and methods

(76) Inventors: James Laurence Hardman JR., West Chester, OH (US); Charles Pierce Crawford II, Harlem, GA (US); Donald Emerson Hershey, Cincinnati, OH (US)

Correspondence Address: DINSMORE & SHOHL, LLP, 1900 CHEMED CENTER, 255 EAST FIFTH STREET, CINCINNATI, OH, 45202, US

(21) Appl. No.: 11/121,610

(22) Filed: May 4, 2005

(51) Int. Cl. B07C 9/00

(52) U.S. Cl. 209/699

(57) ABSTRACT

Systems and methods for detecting a defect in a pallet comprising a load applicator operable to apply a predetermined load force to a top or bottom surface of a pallet, and a sensor operable to detect a portion of a surface opposite the top or bottom surface to which a load force is applied, extending downwardly or upwardly, respectively, more than a predetermined distance.

### FIELD OF THE INVENTION

This invention relates to systems and methods for detecting a defect in a pallet, and particularly to systems and methods operable to detect a defect in a pallet to which a load has been applied.

### BACKGROUND OF THE INVENTION

Inspection for pallet defects has traditionally centered on visual inspection. The visual inspection may consist simply of a user examining a pallet for obvious defects prior to delivery of the pallet for use. In more sophisticated inspections, the visual inspection may utilize photo-sensors to inspect the pallet for defects. The Kawasoe U.S. Pat. No. 5,297,059 discloses an automated testing device comprising photo-sensors, which detect pallet defects prior to use.

As pallet defects can cause interruptions in product conveyance, delivery and/or storage, the need arises for systems that improve defect detection and ensure pallets are functioning properly with minimal defects.

### SUMMARY OF THE INVENTION

According to the present invention, a system for detecting a defect in a pallet is provided. In one embodiment, the system comprises a load applicator operable to apply a predetermined load force to a top or bottom surface of a pallet. Furthermore, the system comprises a sensor operable to detect when a portion of a surface opposite the top or bottom surface, to which a load has been applied, extends downwardly or upwardly, respectively, more than a predetermined distance.

In accordance with another embodiment of the present invention, another system for detecting a defect in a pallet is provided. The system comprises a visual inspection station operable to inspect an unloaded pallet, a load applicator operable to apply a predetermined load force to a top or a bottom surface of a pallet, and a sensor operable to detect a portion of a surface opposite the top or bottom surface of a pallet to which a load force is applied extending downwardly or upwardly, respectively, more than a predetermined distance.

In another embodiment, the invention is directed to a method for detecting a defect in a pallet. The method comprises the steps of inspecting an unloaded pallet at a visual inspection station; applying a predetermined load force to a top or bottom surface of the pallet; inspecting the loaded pallet to detect if a portion of a surface opposite the surface of a pallet to which a load force is applied, extends downwardly or upwardly, respectively, more than a predetermined distance; and diverting a pallet away from a product loading route if the sensor detects a bottom surface of the pallet extending upwardly or downwardly more than the predetermined distance.

The pallet detection systems and methods according to the invention are advantageous as they allow detection of pallet defects that can only be detected when a load has been applied to the pallet, for example when a pallet is in use. Additional features and advantages provided by the pallet detection systems and methods of the present invention will be more fully understood in view of the following detailed description.

### BRIEF DESCRIPTION OF THE DRAWINGS

The following detailed description of specific embodiments of the present invention can be best understood when read in conjunction with the following drawings, where like structure is indicated with like reference numerals and in which:

FIG. 1 is a side schematic view of a system for detecting defects in a pallet according to one or more embodiments of the present invention.

FIG. 2 is a side schematic view of a system for detecting defects in a pallet according to one or more embodiments of the present invention.

FIG. 3 is a side schematic view of a system for detecting defects in a pallet according to one or more embodiments of the present invention.

FIG. 4 is a block diagram of a system for detecting defects in a pallet according to one or more embodiments of the present invention.

### DETAILED DESCRIPTION

The present invention relates to systems and methods for detecting a defect in a pallet, particularly defects which are apparent when a load force is applied to the pallet, for example when products are loaded on the pallet. When examining a pallet prior to use, there may be defects that are not visible to the eye or detectable by photo-sensors. Inspecting a pallet after it has been loaded, in accordance with the present invention, will substantially identify these defects not detected by visual inspection of an unloaded pallet. For example, a board can be split along a grain line such that visual inspection of the unloaded pallet prior to use does not detect the flaw. However, when the pallet is loaded, the board, and ultimately the pallet, will deflect more than is acceptable due to the grain line split. Similarly, defective nails may be present in a pallet, for example, nails that have lost their grip and cannot hold two pieces of wood together. Visual inspection of an unloaded pallet would not likely detect this flaw, but the defect in the pallet may cause pallet failure once the pallet is loaded with product.

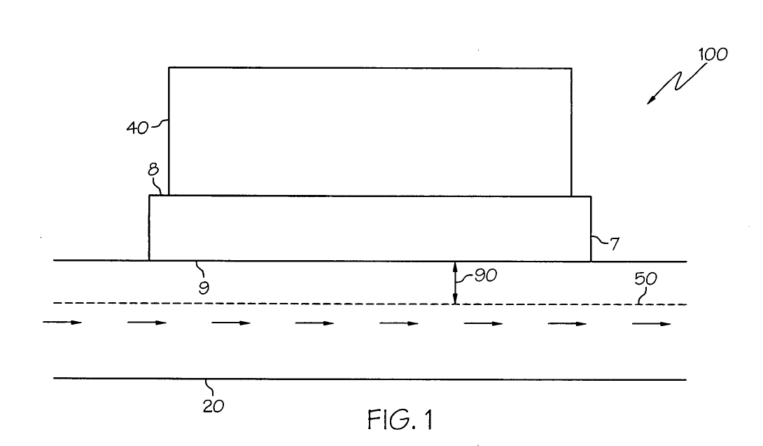

Referring to FIG. 1, a system 100 for detecting a defect in a pallet 7 according to one embodiment of the present invention is provided. The system 100 comprises a load applicator 40 operable to apply a predetermined load force to a top surface 8 or bottom surface 9 of a pallet 7, and also comprises a sensor 50 operable to detect a portion of a surface opposite to the top surface 8 or bottom surface 9 of a pallet 7 to which a load is applied, extending downwardly or upwardly, respectively, more than a predetermined distance 90.

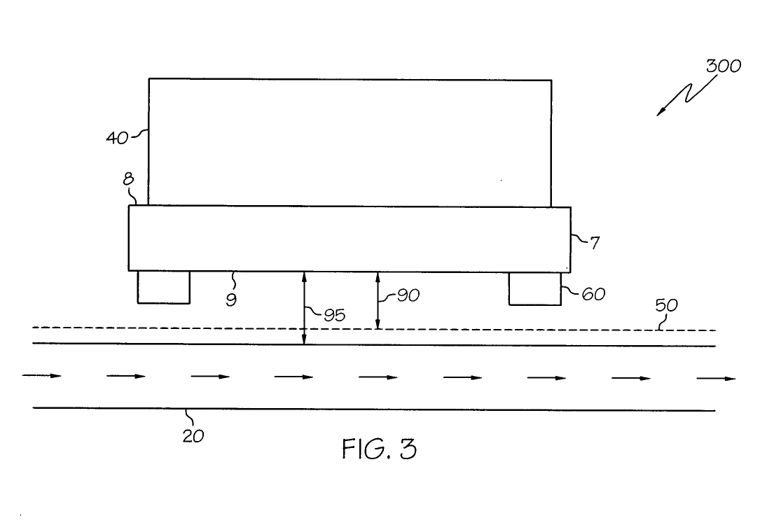

Optionally, the system 100 may also comprise a conveyor 20 operable to deliver a pallet 7 to a load applicator 40. The conveyor 20 may comprise any suitable device operable to deliver a pallet to the system 100. The conveyor 20 may comprise a conveyor mechanism, a forklift, a robot, a human, or the like. In a further embodiment as shown in FIG. 3, the system 300 may also comprise a lifting device 60 operable to lift a pallet 7 off a conveyor 20. The lifting device 60 may comprise any device suitable to lift the pallet 7 off the conveyor and to maintain the lifted pallet 7 with a load 40 applied to the pallet 7, a set distance 95 above the conveyor 20. The lifting device 60 may be adapted to lift the loaded pallet 7, or to lift the unloaded pallet 7 and maintain the lifted pallet 7 when a load is applied. The lifting device 60 may comprise a forklift, a robot, or the like.

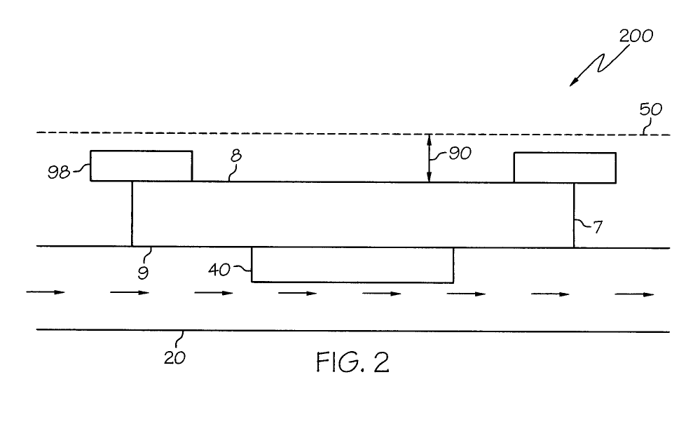

As shown in FIG. 1, the load applicator 40 that is operable to apply a predetermined load force to a top surface 8 or a bottom surface 9 of the pallet 7. In one embodiment as shown in FIG. 1, system 100 may comprise a load applicator 40 operable to apply a load to the top surface 8 of a pallet 7 on a conveyor 20. In another embodiment as shown in FIG. 2, system 200 may comprise a load applicator 40 operable to apply a load to the bottom surface 9 of a pallet 7. Optionally, system 200 may comprise at least one pallet stabilizing mechanism 98 operable to substantially prevent vertical movement of the pallet 7 as a load is applied to the bottom surface 9 of the pallet 7. In yet another embodiment as shown in FIG. 3, the load applicator 40 is operable to apply a load to a pallet 7, for example, on the top surface 8 of the pallet 7 after the pallet 7 is lifted off the conveyor 20 by the lifting device 60.

The load applicator 40 may comprise any suitable weight and/or pressure bearing device or combination of devices known to one skilled in the art sufficient to provide a load force to the pallet 7. The load applicator 40 may also comprise the device used to provide the weight-bearing element to the pallet 7, such as a forklift, a robot, or the like. Numerous load applicator 40 embodiments are contemplated. In one embodiment, the load applicator 40 may comprise filled crates provided to the pallet 7 by a forklift. The load applicator 40 may alternatively comprise weight and pressure bearing air bags. In a further embodiment of the present invention, the load applicator 40 is operable to apply incremental load forces less than the predetermined load force onto the top surface 8 or bottom surface 9 of the pallet 7 until the predetermined load force is achieved. For example, the load applicator 40 may add one weight bearing air bag at a time to test for pallet defects at different weights. Because pallets 7 may be used to transport various products with various weights, a pallet 7 may contain defects that render it useless for transporting products with higher load forces, but may still be effective to transport products with lower load forces.

In further embodiments, the load applicator 40 may also be operable to apply a load to a moving pallet 7. For example, the load applicator 40 may comprise a robot applicable to move in tandem with the pallet. The load applicator 40 may also be operable to remove a load from top surface 8 or bottom surface 9 of a pallet 7 after the load has been applied by the load applicator 40 when the pallet 7 is in motion or at rest.

In another embodiment, the load applicator 40 may also be operable to apply a load to at least one edge portion of a top surface 8 or bottom surface 9 of a pallet 7. In a specific embodiment of the present invention, the load may comprise a torque, or rotational force, applied to at least one edge of a top surface 8 or bottom surface 9 of a pallet 7, wherein the torque is operable to induce deflection in the surface opposite the top surface 8 or bottom surface 9 of the pallet 7 in which the torque is applied. This may result in a portion of the surface opposite containing certain defects to extend downwardly or upwardly a predetermined distance 90.

The system 100 comprises a sensor 50 located, for example, a predetermined distance 90 below or above the surface opposite the top surface 8 or bottom surface 9 of the pallet 7, in which the load is applied. The sensor 50 is operable to detect if a portion of the surface opposite of the pallet 7 extends downwardly or upwardly, respectively, more than a predetermined distance, i.e., more than the distance 90, when a load or torque is applied to the pallet 7 as described above. The sensor 50 may comprise any suitable detection device known to one of ordinary skill in the art. In one embodiment, the sensor 50 may comprise a light beam directed at a detector and adapted to be interrupted by a portion of a pallet surface opposite the surface containing the load when the surface opposite extends, upwardly or downwardly, more than a predetermined distance 90. Alternatively, or in addition, the sensor 50 may comprise a surface that is sensitive to contact, wherein the surface is located a predetermined distance 90 below or above the pallet surface opposite the surface containing the load, such that the surface sensor 50 is contacted if the top surface 8 or bottom surface 9 of the pallet 7 extends upwardly or downwardly, respectively, more than a predetermined distance 90. In another embodiment, the sensor 50 may also be operable to record the distance that the surface opposite to the top surface 8 or bottom surface 9 of a pallet 7, to which a load is applied, extends downwardly or upwardly. For example, the sensor 50 may calculate the distance of flexing or rotation of a pallet 7 surface, after a load or torque has been applied to the pallet 7.

The predetermined distance 90 may comprise any distance set by the user; however, the distance is usually optimized based on the tolerable flex of the pallet 7. Some degree of flexing is acceptable for a pallet 7 after a load has been applied, and the range of tolerable flexing tends to increase when the load force 40 is increased. In one embodiment, the sensor 50 may be oriented a predetermined distance 90 above or below the pallet 7 which equals a distance at or greater than the tolerable flex range. In a specific embodiment, the tolerable flex range 90 may comprise a range of about ½ inch to about 1 inch.

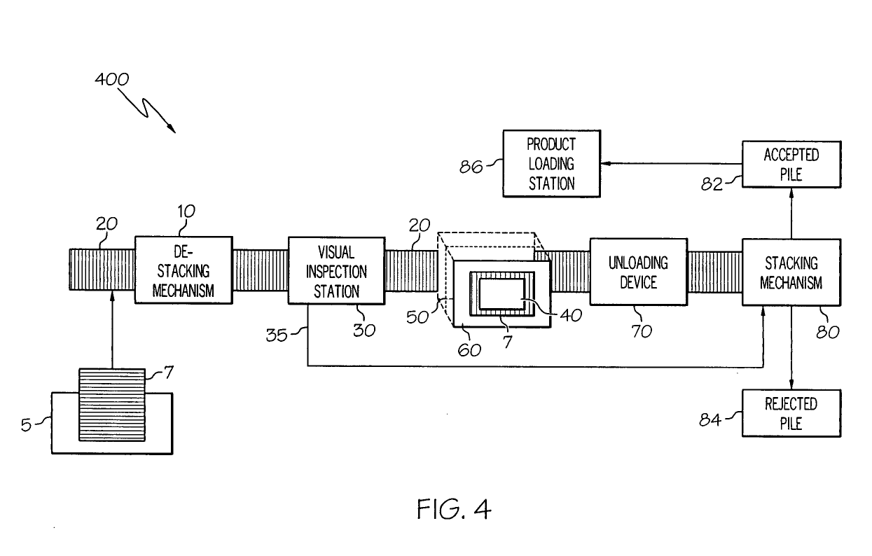

A further embodiment of a system of the present invention is shown in FIG. 4. The system 400 comprises the aforementioned components for detecting defects in a loaded pallet as described above and illustrated in FIGS. 1, 2 and 3. System 400 therefore comprises a load applicator 40 operable to apply a predetermined load force to a top surface 8 or bottom surface 9 of the pallet 7, and a sensor 50 operable to inspect for defects in a pallet 7 with a load force 40 applied thereon. Similar to FIGS. 1-3, the system 400 optionally comprises a conveyor 20 operable to deliver a pallet 7 to the visual inspection station, and a lifting device 60 operable to lift a pallet 7 prior to or after a load has been applied.

The system 400 may also comprise a stacking mechanism 80 configured to separate pallets 7 based on the detection, or non-detection, of a defect in the pallet. For example, in one embodiment, the stacking mechanism 90 is configured to separate and stack pallets 7 into one or more accepted pallet piles 82 and one or more rejected pallet piles 84. The rejected pile 84 may also be adapted to receive pallets 7 having a surface opposite the surface of a pallet 7 to which a load force is applied extending downwardly or upwardly, respectively, more than a predetermined distance 90. The rejected pile 84 may also be adapted to receive pallets 7 diverted from a visual inspection station 30 prior to a load being applied to the pallet 7. The accepted pile 82 may be adapted to receive the remaining pallets 7. The stacking mechanism 80 may comprise any suitable mechanism known to one skilled in the art, including, but not limited to, a forklift, a robot, or the like with appropriate computer control to distribute the pallets 7 to the appropriate accepted pile 82 or rejected pile 84. In a further embodiment, the system may comprise an unloading device 70 operable to remove an applied load 40 from pallets 7 after the pallets 7 have been inspected and prior to the pallets 7 being provided to the stacking mechanism 80. The unloading device 70 may comprise a forklift, a robot, or the like. In a further embodiment, acceptable pallets, including pallets from the accepted piles 82, may be provided to a product loading route, for example for use at a product loading station 86. Conversely, pallets 7 which are rejected on the basis that the sensor 50 detects a portion of the pallet surface opposite the top surface 8 or bottom surface 9 extending downwardly or upwardly, respectively, more than the predetermined distance 90, are diverted away from a product loading route 86 or station.

In accordance with another embodiment as shown in FIG. 4, the system 400 for detecting a defect in a pallet 7 comprises a visual inspection station 30. The visual inspection station 30 inspects an unloaded pallet 7, i.e., a pallet, which does not have a load or torque applied to it, for defects. For example, the visual inspection station 30 may compare the pallet 7 to a set of pallet parameters that may include specifications for length, width, height, etc. In one specific embodiment, the visual inspection station 30 is operable to divert pallets 7 away from the load applicator 40 if the unloaded pallet 7 does not satisfy the set of pallet parameters. In one embodiment, the visual inspection station 30 comprises at least one photo-sensor operable to determine defects in the unloaded pallet 7. The environment in which the pallet 7 is used may dictate the pallet parameters. For example, if the pallet 7 is being used in an automatic storage and retrieval system (ASRS), the pallet parameters will comprise specifications that ensure the pallet 7 properly functions in the ASRS.

In further embodiments of the present invention, the system 400 may comprise a pallet feeding mechanism 5 and a de-stacking mechanism 10. In one embodiment, the conveyor 20 may be operable to receive at least one pallet 7 from a pallet feeding mechanism 5. In one embodiment, conveyor 20 may also receives a stack of pallets 7 from the pallet feeding mechanism 5. The de-stacking mechanism 10 is operable to receive at least one pallet 7 from the conveyor 20. In another embodiment, the de-stacking mechanism 10 is configured to ensure that only one pallet 7 at a time is provided to the visual inspection station 30. The de-stacking mechanism 10 may comprise any suitable device known to one or ordinary skill in the art, such as a forklift, robot, or the like.

In accordance with another embodiment of the present invention, a method for detecting a defect in a pallet 7 is provided. The method includes the steps of inspecting an unloaded pallet 7, and optionally comparing the pallet 7 to a set of pallet parameters, at the visual inspection station 30. Subsequently, the pallet 7 is lifted off a conveyor 20, for example by the use of a lifting device 60, as described, and a predetermined load force is applied to the top surface 8 or bottom surface 9 of the pallet 7 by a load applicator 40. After loading, the pallet 7 is inspected by a sensor 50 operable to detect if a portion of a pallet surface opposite the surface containing the load extends downwardly or upwardly, respectively, more than a predetermined distance 90.

In a specific embodiment of the method, the pallets 7 are separated and stacked into accepted piles 82 and rejected piles 84 through the use of a stacking mechanism 80, wherein the rejected pile 84 is adapted to receive pallets 7 having a surface opposite the surface of a pallet 7 to which a load force is applied extending downwardly or upwardly, respectively, more than a predetermined distance 90 or adapted to receive pallets 7 diverted from the visual inspection station 30, and the accepted pile 82 is adapted to receive the remaining pallets 7.

It is noted that terms like “specifically,” “preferably,” “typically”, and “often” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. It is also noted that terms like “substantially” and “about” are utilized herein to represent the inherent degree of uncertainty that may be attributed to any quantitative comparison, value, measurement, or other representation.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A system for detecting a defect in a pallet, comprising:
a load applicator operable to apply a predetermined load force to a top or bottom surface of a pallet; and
a sensor operable to detect a portion of a surface opposite to the top or bottom surface of a pallet to which a load is applied, extending downwardly or upwardly, respectively, more than a predetermined distance.

2. A system as defined in claim 1 further comprising a conveyor operable to deliver a pallet to the load applicator.

3. A system as defined in claim 2 further comprising a lifting device operable to receive a pallet from a conveyor and further operable to lift a pallet off a conveyor.

4. A system as defined in claim 1, wherein the sensor comprises a light beam adapted to be interrupted by a portion of a surface opposite to the surface of a pallet to which a load force is applied, extending downwardly or upwardly, respectively, more than a predetermined distance.

5. A system as defined in claim 1 further comprising a stacking mechanism configured to separate and stack pallets into a rejected pile and an accepted pile, wherein the rejected pile is adapted to receive pallets having a surface opposite to the surface of a pallet to which a load force is applied, extending downwardly or upwardly, respectively, more than a predetermined distance, and the accepted pile adapted to receive pallets not having surfaces extending downwardly or upwardly more than a predetermined distance.

6. A system as defined in claim 4 further comprising an unloading mechanism operable to remove the predetermined load force applied to a pallet by the load applicator prior to providing a pallet to the stacking mechanism.

7. A system as defined in claim 1 wherein the load applicator is operable to apply incremental load forces less than the predetermined load force onto the top or bottom surface of the pallet until the predetermined load force is achieved.

8. A system as defined in claim 1 wherein the sensor is oriented a predetermined distance below the surface of the pallet such that the predetermined distance is equal to or greater than a tolerable flex range of the pallet.

9. A system as defined in claim 1 wherein the load applicator is operable to apply a load to at least one edge portion of a top or bottom surface of a pallet.

10. A system as defined in claim 9 wherein the load applied to at least one edge portion of a top or bottom surface of a pallet comprises a torque.

11. A system as defined in claim 1 wherein the sensor is further operable to record the distance that the surface opposite to the top or bottom surface of a pallet, to which a load is applied, extends downwardly or upwardly.

12. A system as defined in claim 1 wherein the load applicator is operable to apply a load to a moving pallet.

13. A system as defined in claim 1 wherein the load applicator is operable to remove a load from a pallet after the load has been applied by the load applicator.

14. A system for detecting a defect in a pallet, comprising:
a visual inspection station operable to inspect an unloaded pallet;
a load applicator operable to apply a predetermined load force to a top or a bottom surface of a pallet; and
a sensor operable to detect a portion of a surface opposite the top or bottom surface of a pallet to which a load force is applied extending downwardly or upwardly, respectively, more than a predetermined distance.

15. A system as defined in claim 14 further comprising a conveyor operable to provide a pallet to the visual inspection station.

16. A system as defined in claim 15 wherein the conveyor is further operable to receive at least one pallet from a pallet feeding mechanism.

17. A system as defined in claim 15 further comprising a de-stacking mechanism operable to receive a plurality of pallets from the conveyor and to provide one pallet at a time to the visual inspection station.

18. A system as defined in claim 14 wherein the visual inspection station is further operable to compare the unloaded pallet with a set of pallet parameters.

19. A system as defined in claim 14 wherein the visual inspection station is further operable to divert a pallet, which does not satisfy the set of pallet parameters, away from the load applicator.

20. A system as defined in claim 19 further comprising a stacking mechanism configured to separate and stack pallets into a rejected pile and an accepted pile, wherein the rejected pile is adapted to receive pallets having a surface opposite the surface of a pallet to which a load force is applied extending downwardly or upwardly, respectively, more than a predetermined distance or adapted to receive pallets diverted from the visual inspection station, and the accepted pile is adapted to receive the remaining pallets.

21. A system as defined in claim 14 wherein the visual inspection station comprises at least one photo-sensor.

22. A method for detecting a defect in a pallet, the method comprising the steps of:
inspecting an unloaded pallet at a visual inspection station;
applying a predetermined load force to a top or bottom surface of the pallet;
inspecting the loaded pallet to detect if a portion of a surface opposite the surface of a pallet to which a load force is applied, extends downwardly or upwardly, respectively, more than a predetermined distance; and
diverting a pallet away from a product loading route if the sensor detects a portion of the bottom surface of the pallet extending upwardly or downwardly more than the predetermined distance.

23. A method as defined in claim 22 further comprising separating and stacking pallets into a rejected pile and an accepted pile, wherein the rejected pile is adapted to receive pallets having a surface opposite the surface of a pallet to which a load force is applied extending downwardly or upwardly, respectively, more than a predetermined distance or adapted to receive pallets diverted from the visual inspection station, and the accepted pile is adapted to receive the remaining pallets.
